(19) United States
(12) Patent Application Publication
(10) Pub. No.: US 2023/0120941 A1
(43) Pub. Date: Apr. 20, 2023

(54) GEAR SHIFTING UNIT

(71) Applicant: ZF Friedrichshafen AG, Friedrichshafen (DE)

(72) Inventor: Stefan Renner, Ludwigshafen (DE)

(73) Assignee: ZF Friedrichshafen AG, Friedrichshafen (DE)

(21) Appl. No.: 18/045,583

(22) Filed: Oct. 11, 2022

(30) Foreign Application Priority Data
Oct. 15, 2021 (DE) 10 2021 211 646.9

(51) Int. Cl. F16D 23/06

(52) U.S. Cl. CPC F16D 23/06; F16D 2023/0631; F16D 2023/0656

(57) ABSTRACT

A gear shifting system has a gear shift sleeve that is axially guided with driving toothing on a driving toothing of a transmission shaft, providing at least three shift positions with a rotationally fixed connection of the transmission shaft to a respective transmission component. A respective tooth flank of at least one tooth of one driving toothing has peripheral projections configured axially along the respective tooth between respective adjacent regions where teeth of the other driving toothing move axially in the shift positions of the gear shift sleeve. A gap width of a respective gap between the teeth of the other driving toothing is greater than or equal to a sum formed by a tooth width of the at least one tooth of the one driving toothing and an effective width of the projections.

### RELATED APPLICATIONS

This application claims the benefit of and right of priority under 35 U.S.C. § 119 to German Patent Application no. 10 2021 211 646.9, filed on 15 Oct. 2021, the contents of which are incorporated herein by reference in its entirety.

### FIELD OF THE DISCLOSURE

The invention relates to a gear shifting system, comprising a gear shift sleeve which is guided with a driving toothing in an axially displaceable manner on a driving toothing of a transmission shaft and can thereby be positioned on the transmission shaft in at least three shift positions in which the gear shift sleeve produces a respective rotationally fixed connection of the transmission shaft to a respective transmission component. The invention also relates to a transmission comprising at least one aforementioned gear shifting system.

### BACKGROUND

Gear shifting systems are used in transmissions to make it possible to shift between different transmission ratios in the respective transmission. At least two different shift states, in which transmission components of the transmission are coupled to one another in differing ways in order to realize the different transmission ratios, can usually be realized in a gear shifting system. In addition to force-locking gear shifting systems, in which the transmission components are coupled in the shift states via a frictional engagement, gear shifting systems are also frequently designed as form-locking shifting devices, in which the respectively desired coupling usually takes place via a meshing engagement. Compared to force-locking shifting devices, form-locking shifting devices have the advantage that they exhibit lower drag losses in the open state. Sometimes gear shifting systems are also designed in such a way that three or even more shift states, in which the respective transmission components of the respective transmission are coupled to one another, can be realized.

WO 2014/019807 A1, for example, discloses a form-locking gear shifting system, in which a gear shift sleeve is equipped on an inner periphery with a driving toothing. The gear shift sleeve is guided in an axially displaceable manner on a driving toothing of a first transmission shaft via this driving toothing, and can be moved into different shift positions by axial displacement relative to the first transmission shaft. In a first shift position, the gear shift sleeve connects the first transmission shaft to a second transmission shaft in that the gear shift sleeve engages with its driving toothing in an external toothing of the second transmission shaft. Moreover, in a second shift position, a rotationally fixed connection of the first transmission shaft with a first spur gear is produced, for which purpose the gear shift sleeve engages with a first external toothing in a shift toothing of the first spur gear. The gear shift sleeve is further equipped with a second external toothing, with which the gear shift sleeve in a third shift position engages in a shift toothing of a second spur gear and thereby produces a rotationally fixed connection of the first transmission shaft with the second spur gear.

### SUMMARY

Proceeding from the above-described prior art, it is now the object of the present invention to create a gear shifting system in which at least three different shift positions can be realized, wherein an unintentional departure from a respectively set shift position can be prevented in the most reliable manner possible.

This object is achieved by embodiments of a gear shifting unit disclosed herein. Advantageous further developments will be apparent in light of the present disclosure, including a transmission comprising at least one gear shifting system according to the invention.

According to the invention, a gear shifting system comprises a gear shift sleeve which is guided with a driving toothing in an axially displaceable manner on a driving toothing of a transmission shaft and can thereby be positioned on the transmission shaft in at least three shift positions in which the gear shift sleeve produces a respective rotationally fixed connection of the transmission shaft to a respective transmission component. In the gear shifting system according to the invention, therefore, a gear shift sleeve is provided which serves to implement different shift states of the gear shifting system in that the gear shift sleeve in different shift positions connects one transmission shaft per shift position in a respectively rotationally fixed manner to a respective transmission component. This makes it possible to realize at least three different shift positions of the gear shift sleeve, so that the transmission shaft can also be connected in a respectively rotationally fixed manner to at least three different transmission components via the gear shift sleeve. Particularly preferably, exactly three different shift positions of the gear shift sleeve can be realized, as a result of which the transmission shaft can also be connected in a respectively rotationally fixed manner to three different transmission components. The gear shift sleeve can further preferably also be positioned axially between the at least three shift positions in order to, by assuming a respective intermediate position, be placed in a respective neutral position, in which the gear shift sleeve does not connect the transmission shaft in a rotationally fixed manner to any of the transmission components.

The gear shift sleeve is equipped with driving toothing, by means of which it is guided in an axially movable manner on a driving toothing of the transmission shaft, whereby the different shift positions of the gear shift sleeve, and possibly the neutral positions as intermediate positions, can specifically be assumed via an axial displacement of the gear shift sleeve into a respective axial position of the gear shift sleeve relative to the transmission shaft assigned to the individual shift position or the neutral position. The driving toothings on the gear shift sleeve and transmission shaft are particularly preferably configured in the manner of spline shaft toothings. In each of its shift positions, the gear shift sleeve produces a form-locking connection to the respective transmission component. Therefore, due to the rotationally fixed coupling of the gear shift sleeve with the transmission shaft, the gear shift sleeve indirectly connects the transmission shaft in a rotationally fixed manner to the respective transmission component via the driving toothings.

The gear shift sleeve is preferably in the form of a sleeve-like body having a substantially hollow cylindrical shape. The driving toothing can be configured on an inner diameter or an outer diameter of this body, whereby the driving toothing on the side of the transmission shaft is then configured on an outer diameter or an inner diameter. The driving toothing of the transmission shaft can be configured directly on the transmission shaft, but it is particularly preferable for a separate coupling body to be fastened in a rotationally fixed manner to the transmission shaft, on which the driving toothing of the transmission shaft is configured.

The invention now includes the technical teaching that at least one tooth of the one driving toothing is respectively equipped on at least one respective tooth flank with projections which each project in peripheral direction relative to the at least one respective tooth flank and are configured axially along the respective tooth between respectively adjacent regions in which teeth of the other driving toothing are moved axially in the shift positions of the gear shift sleeve. A gap width of a respective gap between the teeth of the other driving toothing is furthermore selected to be greater than or equal to a sum formed by a tooth width of the at least one tooth of the one driving toothing which engages in the respective gap and an effective width of the projections in peripheral direction of the at least one tooth.

In other words, therefore, at least one tooth of the one driving toothing comprises projections which are configured on at least one tooth flank of the at least one tooth and project in peripheral direction, and are disposed axially between regions of the at least one tooth in which teeth of the other driving toothing are individually disposed when the gear shift sleeve is positioned in the shift positions. A respective gap between the teeth of the other driving toothing is moreover selected such that a width of the gap is greater than or equal to a width of the at least one tooth of the one driving toothing which engages in the gap and the additional extension in peripheral direction effectively caused by the projections provided on the at least one tooth.

Such a configuration of a gear shifting system has the advantage that a shifting device can be implemented, with which at least three shift states in which the transmission shaft is respectively connected in a rotationally fixed manner to a respective associated transmission component can be realized. The interaction of the at least one tooth of the one driving toothing equipped with the projections with the teeth of the other driving toothing can also reliably prevent an unintentional departure from a respectively selected shift position under load. Because, under load and the associated transmission of torque between the transmission shaft and the transmission component connected to said transmission shaft in a rotationally fixed manner via the gear shift sleeve, the teeth of the driving toothing of the gear shift sleeve are in contact with a respective tooth flank on a respective associated tooth flank of the teeth of the driving toothing of the transmission shaft. The projections, which are respectively configured axially between the regions on the at least one tooth flank of the at least one tooth of the one driving toothing, thereby form-lockingly prevent a displacement of the other driving toothing out of the current, axial region relative to the one driving toothing. The reason for this is that, when the tooth flanks are in contact with one another, the at least one tooth of the one driving toothing, which is thus widened axially in sections, form-lockingly prevents at least one tooth of the other driving toothing from axially moving on by.

Only when there is substantially no load can the gear shift sleeve be rotated relative to the transmission shaft in peripheral direction to such an extent that the at least one tooth of the other driving toothing can move past the projections of the at least one tooth of the one driving toothing. This is made possible because the gap widths between the teeth of the other driving toothing are selected to be at least as large as the sum of the extension of the at least one tooth which engages in the individual gap and the effective width of the projections on the at least one tooth flank. All in all, this makes it possible to implement a gear shifting system, by means of which the transmission shaft can be connected in a respectively rotationally fixed manner to at least three transmission components in different shift positions of the gear shift sleeve, whereby an unintentional departure from a currently selected shift position is reliably prevented under load. On the other hand, when there is substantially no load, axial displacement of the gear shift sleeve relative to the transmission shaft and thus a departure from a currently selected shift position can be carried out without difficulty. This can be implemented with low production costs by making a minor adjustment to at least one tooth of the one driving toothing.

In the context of the invention, “axial” means an orientation in the extension direction of a common axis of rotation of the transmission shaft and the gear shift sleeve, whereas “radial” means an orientation in the diameter direction of the transmission shaft and the gear shift sleeve. “In peripheral direction” means an orientation in the direction of a periphery of the transmission shaft or the gear shift sleeve.

“Tooth flanks” of a respective tooth of the driving toothings means the boundaries of the individual tooth in peripheral direction. On the one driving toothing, at least one tooth is respectively equipped on at least one of its tooth flanks with the projections which ultimately provide the at least one tooth a greater tooth width axially between the regions assigned to the shift positions of the gear shift sleeve. Preferably, however, a plurality of teeth or even all of the teeth on the one driving toothing are equipped with projections, whereby, in the case of a plurality of teeth having projections, said teeth are in particular distributed evenly over the periphery of the one driving toothing.

A “gap” between teeth refers to the free space between adjacent teeth in peripheral direction, i.e. a tooth gap between successive teeth of the respective toothing. A gap width refers to the distance in peripheral direction between successive teeth of the respective toothing, i.e. the dimension of the size of the respective gap.

In the context of the invention, the “effective width” of the projections is to be understood as the effective widening of the at least one tooth by the projections in peripheral direction. If projections are configured on both tooth flanks of the at least one tooth, the effective width is composed of the widths of the projections on both tooth flanks.

In the context of the invention, the projections configured on the at least one tooth flank of the respective tooth of the one driving toothing can extend over a part or the entire tooth height of the respective tooth. Moreover, in the context of the invention, the one driving toothing can be the driving toothing of the transmission shaft and the other driving toothing can be the driving toothing of the gear shift sleeve, or vice versa.

In WO 2014/019807 A1, no additional measures are taken to prevent unintentional departure from a respectively selected shift position of the gear shift sleeve. The axial holding of the gear shift sleeve in a shift position axially between further shift positions, in particular, is problematic, because the gear shift sleeve can unintentionally move axially in both directions out of this position.

According to one embodiment of the invention, the at least one tooth of the one driving toothing is equipped on both tooth flanks with projections which are configured axially along the at least one tooth between the respectively adjacent regions and such that they project in both directions in peripheral direction. This advantageously ensures that there is no unintentional departure from the currently selected shift position of the gear shift sleeve, even in the event of load changes. Because, in the event of a load change and an associated change in contact of the tooth flanks of the driving toothings of the gear shift sleeve and the transmission shaft, the projections on the respective other tooth flanks of the at least one tooth of the one driving toothing form-lockingly prevent unintentional axial displacement of the gear shift sleeve out of the current shift position. In the context of the invention, however, the at least one tooth of the one driving toothing can also be equipped with the projections on only one of its tooth flanks.

According to one possible configuration of the invention, the projections respectively merge continuously into the regions of the respective tooth flank. This does not result in an abrupt widening of the at least one tooth in the region of the projections; the widening instead takes place continuously to a maximum dimension of the respective projection in peripheral direction. In a further development of this possible configuration, the respective transition is linear. In the context of the invention, however, another transition can alternatively be made, for example a rounded and/or elliptical transition.

A further embodiment of the invention is that, on at least one tooth of the other driving toothing, a respective tooth flank of the at least one tooth of the other driving toothing which faces the respective opposite projections merges directly into axial end faces of this tooth. Advantageously, when this tooth flank is in contact with the tooth flank comprising the projections, this directly prevents further axial displacement of the gear shift sleeve relative to the transmission shaft as a result of the thus immediately occurring axial abutment of the respective end face of the at least one tooth of the other driving toothing. In the extreme case, the transition can be based on a 90° angle between the respective tooth flank and the respective end face. In the context of the invention, however, a continuous transition of the tooth flank of the at least one tooth of the other driving toothing into the respective end face can be selected here as well, for example as a linear or rounded transition.

In a further development of the invention, one driving toothing is configured on the side of the transmission shaft and the other driving toothing is configured on the side of the gear shift sleeve. The driving toothing of the gear shift sleeve is particularly preferably configured on an inner periphery of the gear shift sleeve.

The gear shift sleeve is alternatively or additionally equipped on an inner and/or outer periphery with at least one shift toothing on which a respective meshing engagement with a respective associated toothing of the respective transmission component can be produced in the respective shift position. Particularly preferably, a first shift toothing is configured on an axial end of the gear shift sleeve for a meshing engagement with one or more transmission components disposed on this axial side of the gear shift sleeve and a second shift toothing, which is used for a meshing engagement with one or more transmission components provided on this axial side of the gear shift sleeve, is additionally configured on a thereto opposite axial end of the gear shift sleeve. The individual shift toothing can be configured in the manner of a claw toothing, which, when the gear shift sleeve is displaced into the respective shift position, engages in a corresponding toothing of the respective transmission component, whereby this toothing is designed as a claw toothing as well.

According to a further possible configuration of the invention, each of the transmission components is present as a respective further transmission shaft. In this case, the gear shift sleeve carries out a respective rotationally fixed connection of the transmission shaft with a respective further transmission shaft in each of its shift positions. One or even more of the transmission components can also be present in the form of spur gears, however, which are connected in a rotationally fixed manner to the transmission shaft via the gear shift sleeve in the respective shift position of the gear shift sleeve.

In a further development of the invention, the gap width is selected to be greater than the sum of the tooth width of the at least one tooth of the one driving toothing and the effective width of the projections. This has the advantage that, in the substantially load-free state of the gear shifting system, the gear shift sleeve can easily be displaced relative to the transmission shaft from the respective shift position because there is a sufficient tooth gap between the teeth of the other driving toothing. The gap width is particularly preferably selected to be significantly larger than the sum of the tooth width and the effective width of the projections.

Another subject matter of the invention is a transmission, which is in particular a motor vehicle transmission. This transmission is equipped with at least one gear shifting system according to the invention, which can be designed according to any one or more of the above-described variants. The motor vehicle transmission can particularly preferably be an automatic transmission.

The invention is not limited to the stated combination of the features of the main claim or the claims dependent thereon. Individual features can also be combined with one another, including those that emerge from the claims, the following description of a preferred embodiment of the invention or directly from the drawings. References in the claims to the drawings by means of reference signs is not intended limit the scope of protection of the claims.

### BRIEF DESCRIPTION OF THE DRAWINGS

Advantageous embodiments of the invention, which are discussed below, are shown in the drawings. The figures show:

FIG. 1: a sectional view of a gear shifting system according to a preferred embodiment and in a first shift state;

FIG. 2: a tangential section through driving toothings of the gear shifting system in the first shift state of FIG. 1;

FIG. 3: a sectional view of the gear shifting system according to the invention in a second shift state;

FIG. 4: a tangential section through the driving toothings of the gear shifting system in the second shift state of FIG. 2;

FIG. 5: a sectional view of the gear shifting system according to the invention in a third shift state;

FIG. 6: a tangential section through the driving toothings of the gear shifting system in the third shift state of FIG. 5;

FIG. 7: a sectional view of the gear shifting system according to the invention in a fourth shift state;

FIG. 8: a tangential section through the driving toothings of the gear shifting system in the fourth shift state of FIG. 7;

FIG. 9: a sectional view of the gear shifting system according to the invention in a fifth shift state; and

FIG. 10: a tangential section through the driving toothings of the gear shifting system in the fifth shift state of FIG. 9.

### DETAILED DESCRIPTION

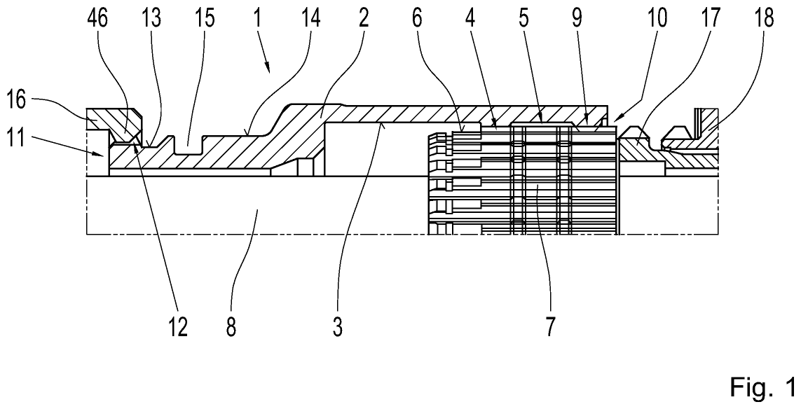

FIG. 1 shows a sectional view of a gear shifting system 1, which is provided in a transmission. This transmission is preferably a motor vehicle transmission, which is in particular designed as an automatic transmission. The gear shifting system 1 is configured according to a preferred embodiment of the invention.

The gear shifting system 1 in this case comprises a gear shift sleeve 2, which is configured in a sleeve-like manner as a hollow cylindrical body and is equipped on an inner diameter 3 with a driving toothing 4. The gear shift sleeve 2 is guided on this driving toothing 4 in an axially displaceable manner on a driving toothing 5 configured on an outer diameter 6 of a coupling body 7. The coupling body 7 is fastened to a transmission shaft 8 in a rotationally fixed and axially immovable manner. In the present case, the two driving toothings 4 and 5 are both designed in the manner of driving toothings.

As can further be seen in FIG. 1, the gear shift sleeve 2 is equipped on the inner diameter 3 with a shift toothing 9, which is axially spaced apart from the driving toothing 4 and is designed here as a claw toothing. This shift toothing 9 is configured in the region of an axial end 10 of the gear shift sleeve 2. On an axial end 11 opposite to the end 10, the gear shift sleeve 2 is moreover equipped with a further shift toothing 12, whereby this shift toothing 12 is provided on an outer diameter 13 of the gear shift sleeve 2 and is configured as a claw toothing. Also in the region of the axial end 11 and axially adjacent to the shift toothing 12, the gear shift sleeve 2 is additionally equipped on an outer diameter 14 with a peripheral groove 15, which serves to engage an actuating element, such as a shift fork, via which the axial displacement of the gear shift sleeve 2 relative to the transmission shaft 8 can be initiated.

The gear shift sleeve 2 can be moved axially on the transmission shaft 8 into different shift positions in order to connect the transmission shaft 8 in each of the shift positions in a form-locking, rotationally fixed manner to a respective transmission component 16 or 17 or 18. These transmission components 16 to 18 in this case are further transmission shafts of the transmission. Therefore, three different rotationally fixed connections of the transmission shaft 8 can be realized via the gear shifting system according to the invention.

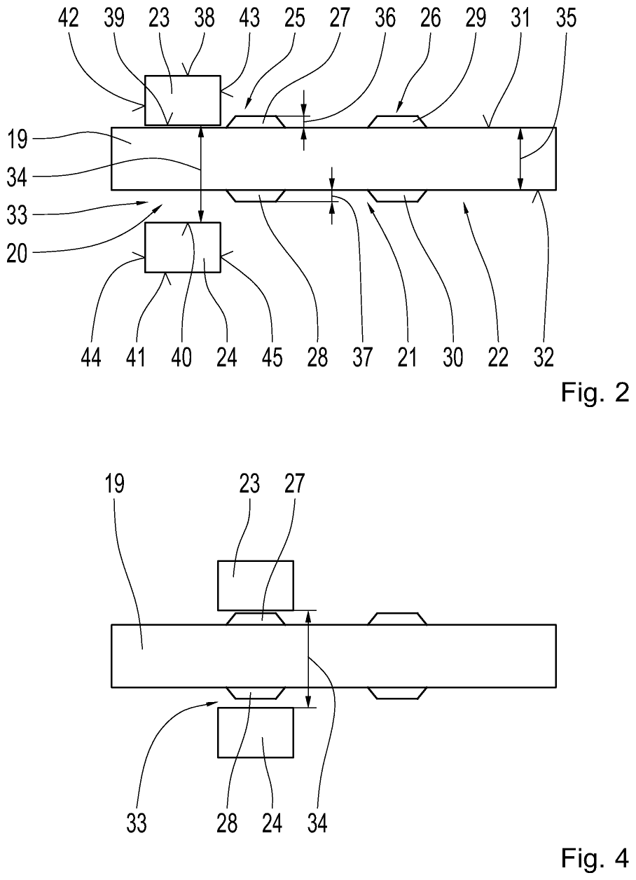

As a special feature, the driving toothings 4 and 5 of the gear shifting system 1 are designed in such a way that an unintentional departure from a currently selected shift position is prevented for the gear shift sleeve 2. This design of the driving toothing 4 and 5 will now be described in more detail with reference to the illustration in FIG. 2, which shows a tangential section through the driving toothing 4 and 5.

In FIG. 2, a tooth 19 of the driving toothing 5 can be seen, whereby all of the teeth of the driving toothing 5 can be configured in this way or only one tooth or individual teeth of the driving toothing 5 are designed in this way. In the latter case, the corresponding teeth are in particular distributed evenly over the periphery of the driving toothing 5.

The tooth 19 has an axial extension on the coupling body 7 which corresponds to the axial displacement range of the gear shift sleeve 2 on the transmission shaft 8. There are three regions 20, 21 and 22 along the tooth 19, in which the gear shift sleeve 2 is respectively axially positioned in a respective one of its shift positions with teeth 23 and 24 of its driving toothing 4. Projections 27 to 30 are provided on the tooth 19 in intermediate regions 25 and 26 axially between these regions 20, 21 and 22. The projections 27 and 29 are provided on a tooth flank 31 of the tooth 19 and the projections 28 and 30 are provided on a tooth flank 32 of the tooth 19. Whereas the projections 27 and 28 are provided axially at the same height in the intermediate region 25 and thus between the regions 20 and 21 and extend in peripheral direction opposite to one another, the projections 29 and 30 are located in the intermediate region 26 and thus between the regions 21 and 22. In this case, the projection 29 projects in peripheral direction in one direction relative to the tooth flank 31, whereas the projection 30 is configured such that to projects in peripheral direction in the opposite direction relative to the tooth flank 32. The transitions of the individual projection 27 or 28 or 29 or 30 into the respectively axially adjacent regions 20 and 21 or 21 and 22 of the tooth 19 are all configured to be continuous, whereby this is implemented here in the form of a linear transition.

A gap 33 between the teeth 23 and 24 of the driving toothing 4 of the gear shift sleeve 2 is designed with a gap width 34 which is greater than the sum of a tooth width 35 of the tooth 19 and the effective width of the projections 27 to 30, which is composed of the width 36 of the projections 27 and 29 and the width 37 of the projections 28 and 30 in peripheral direction. As can also be seen in FIG. 2, the tooth flanks 38 and 39 or 40 and 41 of the teeth 23 and 24, in the intermediate gap 33 of which the tooth 19 equipped with the projections 27 to 30 engages, merge directly and with an edge into axial end faces 42 and 43 or 44 and 45 of the respective tooth 23 or 24.

When the gear shift sleeve 2 is positioned with its driving toothing 4 in one of the regions 20 to 22, and thus in one of its shift positions in which the gear shift sleeve 2 respectively produces a rotationally fixed connection of the transmission shaft 8 with one of the transmission components 16 to 18, one of the teeth 23 or 24 rests with its tooth flank 39 or 40 against the tooth flank 31 or 32 of the tooth 19 of the driving toothing 5 under load. An axial displacement of the gear shift sleeve 2 relative to the transmission shaft 8 under load and thus a departure from the respective selected shift position is form-lockingly prevented by the interaction of one of the end faces 42 or 43 or 44 or 45 of the tooth 23 or 24 with the projection 27 or 29 or 28 or 30 which is axially adjacent in this direction.

FIGS. 1 and 2 show a shift state of the gear shifting system 1, in which the gear shift sleeve 2 is axially positioned in a first shift position in which the gear shift sleeve 2 connects the transmission shaft 8 in a rotationally fixed manner to the transmission component 16 via a meshing engagement of the shift toothing 12 with a toothing 46 of the transmission component 16. Under load, departure from this shift position is prevented for the driving toothings 4 and 5 by the interaction of the projection 27 of the tooth 19 with the end face 43 of the tooth 23.

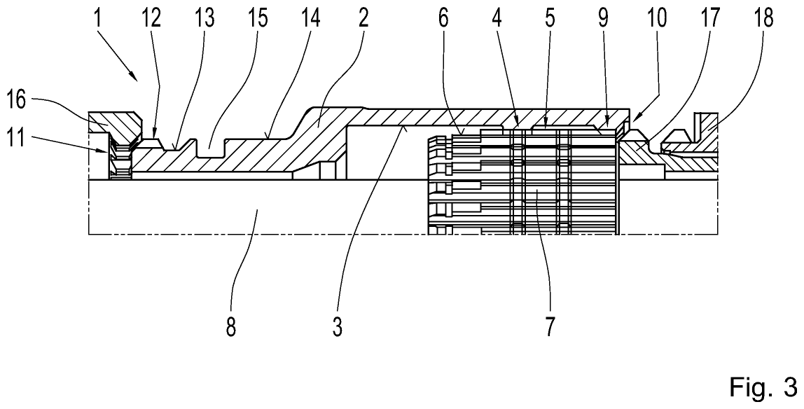

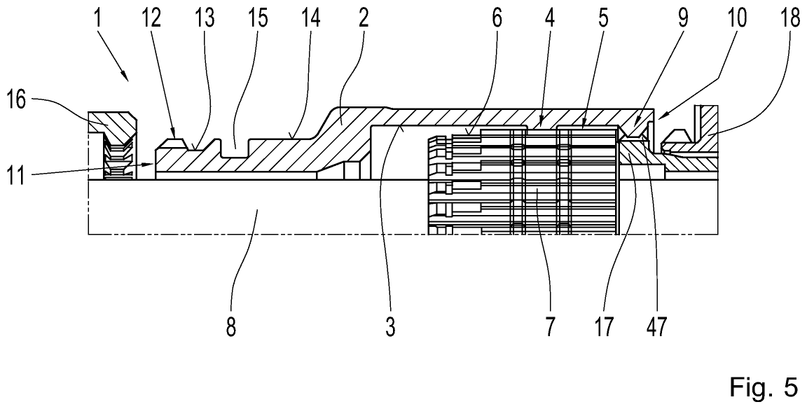

The gear shift sleeve 2 can be displaced axially from the shift position shown in FIG. 1 into a neutral position shown in FIGS. 3 and 4 only when there is substantially no load on the meshing engagements of the driving toothings 4 and 5 and the gear shift sleeve 2 can then be rotated in peripheral direction relative to the coupling body 7. As can be seen in particular in FIG. 4, this axial displacement when there is substantially no load is made possible by the sufficiently large gap width 34 of the gap 33 between the teeth 23 and 24.

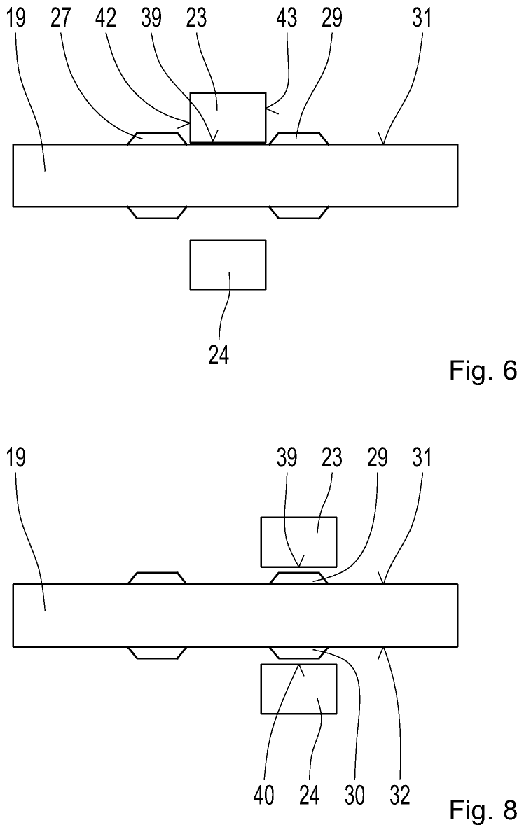

From the neutral position shown in FIGS. 3 and 4, the gear shift sleeve 2 can then not only be displaced into the shift position shown in FIG. 1, but also into a second shift position shown in FIGS. 5 and 6. In this second shift position, the gear shift sleeve 2 then engages with its shift toothing 9 in a toothing 47 of the transmission component 17, as a result of which the transmission component 17 and the transmission shaft 8 are connected to one another in a rotationally fixed manner via the gear shift sleeve 2. As can be seen in FIG. 6, respectively in interaction with the respective axially adjacent projection 27 and 29 of the tooth 19, the two end faces 42 and 43 of the tooth 23 form-lockingly prevent an axial displacement of the gear shift sleeve 2 in both axial directions under load, because the tooth 23 rests with its tooth flank 39 against the tooth flank 31 of the tooth 19 under load.

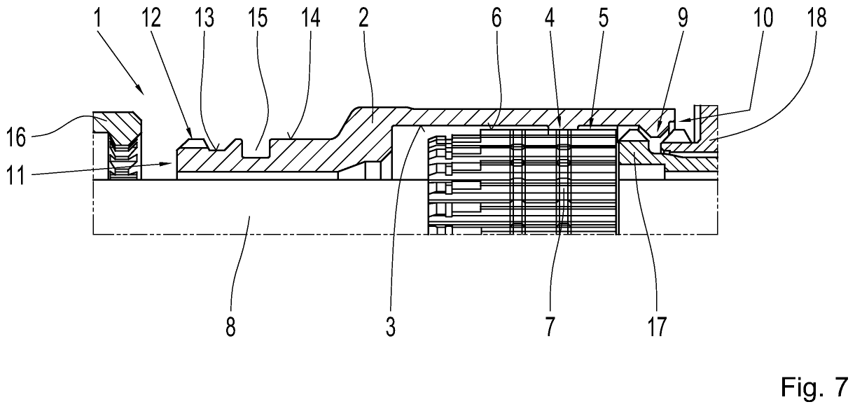

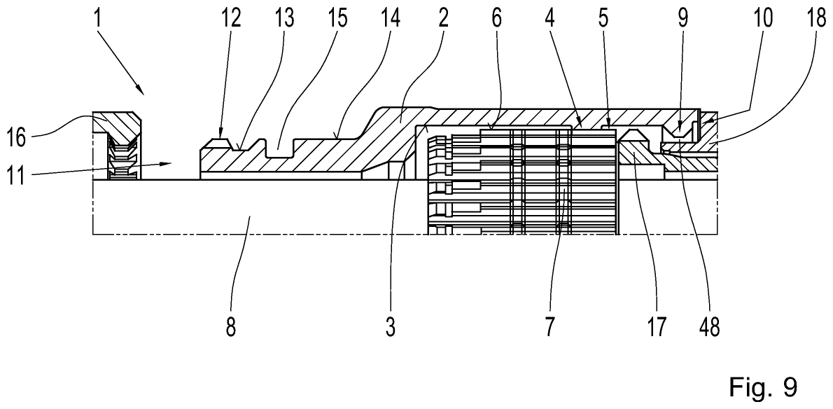

The gear shift sleeve 2 can be displaced from the second shift position shown in FIGS. 5 and 6 into either the neutral position of FIGS. 3 and 4 ora neutral position shown in FIGS. 7 and 8 only when there is substantially no load. Here, too, the reason is that, in the at least almost load-free state, the gear shift sleeve 2 can be rotated with its driving toothing 4 relative to the driving toothing 5 so far in peripheral direction that the teeth 23 and 24 no longer rest with their tooth flanks 39 and 40 against the respective facing tooth flank 31 and 32 of the tooth 19. The teeth 23 and 24 can therefore move axially past the projections 29 and 30.

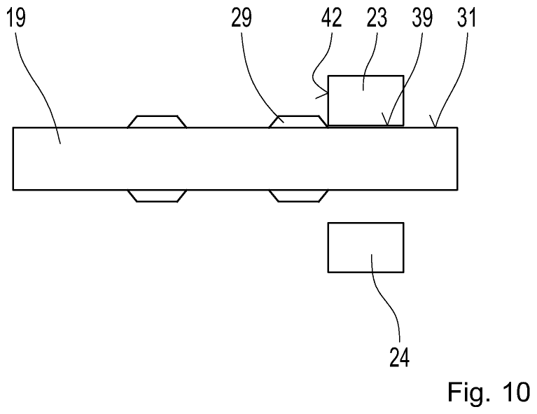

The gear shift sleeve 2 can also be displaced axially from the neutral position shown in FIGS. 7 and 8 into a third shift position, which can be seen in FIGS. 9 and 10. In this third shift position, the gear shift sleeve 2 engages with its shift toothing 9 in a toothing 48 of the transmission component 18, as a result of which the gear shift sleeve 2 connects the transmission shaft 8 and the transmission component 18 to one another in a rotationally fixed manner. As can be seen in FIG. 10, a departure from this third shift position is again prevented under load because the tooth 23 rests with its tooth flank 39 against the tooth flank 31 of the tooth 19 under load, which form-lockingly prevents an axial displacement as a result of the interaction of the end face 42 with the projection 29. A return movement into the neutral position shown in FIGS. 7 and 8 can be undertaken only when there is substantially no load.

The use of the embodiments of a gear shifting system according to the invention enables the realization of at least three different shift positions, whereby an unintentional departure from a respectively selected shift position under load is prevented in a reliable manner.

### LIST OF REFERENCE NUMERALS

1 Gear shifting system

2 Gear shift sleeve

3 Inner diameter

4 Driving toothing

5 Driving toothing

6 Outer diameter

7 Coupling body

8 Transmission shaft

9 Shift toothing

10 End

11 End

12 Shift toothing

13 Outer diameter

14 Outer diameter

15 Groove

16 Transmission component

17 Transmission component

18 Transmission component

19 Tooth

20 Region

21 Region

22 Region

23 Tooth

24 Tooth

25 Intermediate region

26 Intermediate region

27 Projection

28 Projection

29 Projection

30 Projection

31 Tooth flank

32 Tooth flank

33 Gap

34 Gap width

35 Tooth width

36 Width

37 Width

38 Tooth flank

39 Tooth flank

40 Tooth flank

41 Tooth flank

42 End face

43 End face

44 End face

45 End face

46 Toothing

47 Toothing

48 Toothing

1. A gear shifting system (1), for use with a transmission shaft (8) having shaft driving toothing (5) the gear shifting system comprising:
a gear shift sleeve (2) configured to be guided with a sleeve driving toothing (4) in an axially displaceable manner on the shaft driving toothing (5) of the transmission shaft (8) and can thereby be positioned on the transmission shaft (8) in at least three shift positions in which the gear shift sleeve (2) produces a respective rotationally fixed connection of the transmission shaft (8) to a respective transmission component (16; 17; 18);
wherein at least one tooth (19) of the shaft driving toothing (5) is respectively equipped on at least one respective tooth flank (31, 32) and has projections (27 to 30) which each project in a peripheral direction relative to the at least one respective tooth flank (31, 32) and which are configured axially along the respective tooth (19) between respectively adjacent regions (20, 21, 22) in which teeth (23, 24) of the sleeve driving toothing (4) are moved axially in the shift positions of the gear shift sleeve (2); and
wherein a gap width (34) of a respective gap (33) between the teeth (23, 24) of the sleeve driving toothing (4) is greater than or equal to a sum formed by a tooth width (35) of the at least one tooth (19) of the shaft driving toothing (5) which engages in the respective gap (33) and an effective width of the projections (27 to 30) in a peripheral direction of the at least one tooth (19).

2. The gear shifting system (1) according to claim 1, wherein the at least one tooth (19) of the shaft driving toothing (5) is equipped on two respective tooth flanks (31, 32) and has projections (27 to 30) which are configured axially along the at least one tooth (19) between the respectively adjacent regions (20, 21, 22) and such that the projections project in both peripheral directions.

3. The gear shifting system (1) according to claim 1, wherein the projections (27 to 30) respectively merge continuously into the regions (20, 21, 22) of the respective tooth flank (31, 32).

4. The gear shifting system (1) according to claim 3, wherein the respective transition is linear.

5. The gear shifting system (1) according claim 1, wherein in at least one tooth (23, 24) of the sleeve driving toothing (4), a respective tooth flank (39; 40) of the at least one tooth (23, 24) of the sleeve driving toothing (4) which faces the respectively opposite projections (27, 29; 28, 30) merges directly into axial end faces (42, 43; 44, 45) of the at least one tooth (23, 24).

6. The gear shifting system (1) according to claim 1, wherein the shaft driving toothing (5) is configured on a side of the transmission shaft (8) and the sleeve driving toothing (4) is configured on a side of the gear shift sleeve (2).

7. The gear shifting system (1) according to claim 1, wherein the gear shift sleeve (2) is equipped on an inner and/or outer periphery with at least one shift toothing (9, 12) on which a respective meshing engagement with a respective associated toothing (46; 47; 48) of a respective transmission component (16; 17; 18) can be produced in the respective shift position.

8. The gear shifting system (1) according to claim 1, wherein each of the respective transmission components (16, 17, 18) is present as a respective further transmission shaft.

9. The gear shifting system (1) according to claim 1, wherein a gap width (34) is selected to be greater than the sum of the tooth width (35) of the at least one tooth (19) of the shaft driving toothing (5) and the effective width of the projections (27 to 30).

10. A motor vehicle transmission, comprising at least one gear shifting system (1) according to claim 1.
